(19) United States
(12) Patent Application Publication
(10) Pub. No.: US 2005/0099280 A1
(43) Pub. Date: May 12, 2005

(54) GPS velocity detector for automobile

(76) Inventor: Wen Chang Wang, Tainan Hsien (TW)

Correspondence Address: NIKOLAI & MERSEREAU, P.A., 900 SECOND AVENUE SOUTH, SUITE 820, MINNEAPOLIS, MN, 55402, US

(21) Appl. No.: 10/705,302

(22) Filed: Nov. 10, 2003

(51) Int. Cl. B60Q 1/00

(52) U.S. Cl. 340/441; 340/936

(57) ABSTRACT

A velocity detector includes a GPS receiver, a velocity record arrangement, a velocity signal input device, a warning device, and a release button. Thus, when the travel velocity of the automobile is greater than the uppermost velocity limit or smaller than the lowermost velocity limit stored in the memory of the velocity record arrangement, the output port of the velocity record arrangement immediately outputs a signal to the warning device so as to emit a warning sound or warning light to remind the user, thereby providing a warning effect to the user, so as to protect the driver's safety during movement of the automobile.

### BACKGROUND OF THE INVENTION

1. Field of the Invention

The present invention relates to a GPS (Global Positioning System) velocity detector, and more particularly to a GPS velocity detector for an automobile.

2. Description of the Related Art

A conventional GPS (Global Positioning System) is used to locate the present position of the automobile. However, the conventional GPS has to co-operate with an electronic map to indicate the present position of the automobile, so as to provide a navigation guide aid function to the driver, thereby limiting the versatility of the conventional GPS.

### SUMMARY OF THE INVENTION

The primary objective of the present invention is to provide a velocity detector for a wheeled vehicle, such as an automobile or the like.

Another objective of the present invention is to provide a velocity detector, wherein when the travel velocity of the automobile is greater than the uppermost velocity limit or smaller than the lowermost velocity limit stored in the memory of the velocity record arrangement, the output port of the velocity record arrangement immediately outputs a signal to the warning device so as to emit a warning sound or warning light to remind the user, thereby providing a warning effect to the user, so as to protect the driver's safety during movement of the automobile.

In accordance with the present invention, there is provided a velocity detector, comprising:
a GPS (Global Positioning System) receiver having an output port;
a velocity record arrangement connected to the output port of the GPS receiver and provided with a memory and an output port;
a velocity signal input device connected to the GPS receiver; and
a warning device connected to the output port of the velocity record arrangement.

Further benefits and advantages of the present invention will become apparent after a careful reading of the detailed description with appropriate reference to the accompanying drawings.

### BRIEF DESCRIPTION OF THE DRAWING

FIG. 1 is a block diagram of a velocity detector in accordance with the preferred embodiment of the present invention.

### DETAILED DESCRIPTION OF THE INVENTION

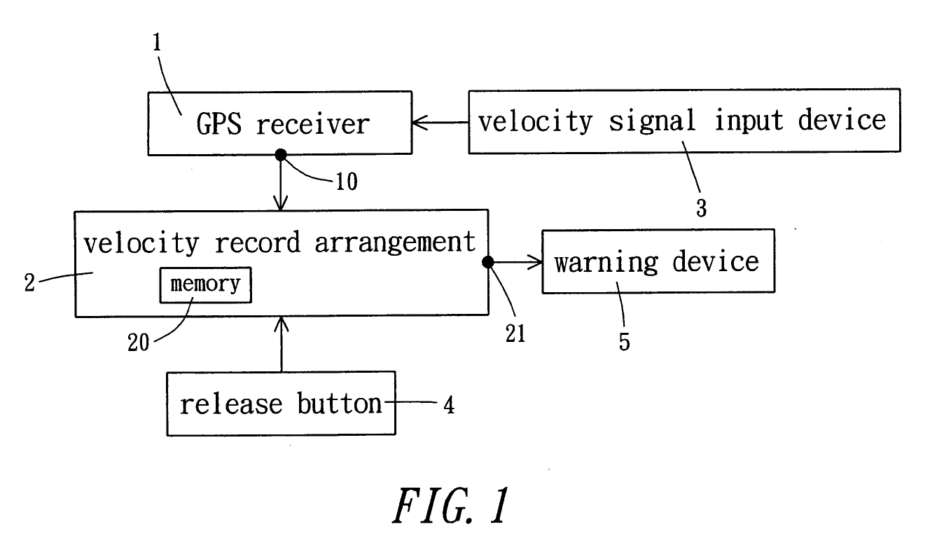

Referring to FIG. 1, a velocity detector in accordance with the preferred embodiment of the present invention comprises a GPS (Global Positioning System) receiver 1, a velocity record arrangement 2, a velocity signal input device 3, a release button 4, and a warning device 5.

The GPS receiver 1 is mounted on the automobile and has an output port 10. In practice, according to the Doppler effect, the frequency shift between the transmitting frequency of the GPS satellite and the frequency of the GPS receiver is proportion to the relative velocity of the GPS receiver. Thus, when the automobile is traveled at different velocities, the GPS receiver 1 produces different velocity signals, and the velocity signals are transmitted outward through the output port 10 of the GPS receiver 1.

The velocity record arrangement 2 is connected to the output port 10 of the GPS receiver 1 to receive the velocity signals from the output port 10 of the GPS receiver 1. The velocity record arrangement 2 is provided with a memory 20 and an output port 21. The memory 20 of the velocity record arrangement 2 is used to store the velocity signals from the output port 10 of the GPS receiver 1.

The velocity signal input device 3 is connected to the GPS receiver 1 to input a predetermined velocity value into the GPS receiver 1.

The release button 4 is connected to the velocity record arrangement 2 so as to release the velocity value recorded in the velocity record arrangement 2 when the release button 4 is pressed by the user, so that the user can reset the predetermined velocity value. If the velocity value recorded in the velocity record arrangement 2 is not released by the release button 4, the original predetermined velocity value still works.

The warning device 5 is connected to the output port 21 of the velocity record arrangement 2 to provide a warning effect. Preferably, the warning device 5 is a buzzer or a warning lamp.

In practice, the velocity detector in accordance with the preferred embodiment of the present invention has two velocity setting modes described as follows.

In the first control mode, the travel velocity is preset in a static manner. The user can key the uppermost velocity limit into the velocity signal input device 3. Then, the uppermost velocity limit is transmitted through the output port 10 of the GPS receiver 1, and is then stored in the memory 20 of the velocity record arrangement 2. In addition, the user can key the lowermost velocity limit into the velocity signal input device 3. Then, the lowermost velocity limit is transmitted through the output port 10 of the GPS receiver 1, and is then stored in the memory 20 of the velocity record arrangement 2.

In such a manner, when the travel velocity of the automobile is greater than the uppermost velocity limit stored in the memory 20 of the velocity record arrangement 2 or smaller than the lowermost velocity limit stored in the memory 20 of the velocity record arrangement 2, the output port 21 of the velocity record arrangement 2 immediately outputs a signal to the warning device 5 so as to emit a warning sound or warning light to remind the user, thereby providing a warning effect to the user.

In the second control mode, the travel velocity is set in a dynamic manner during movement of the automobile. The user can key the uppermost velocity limit into the velocity signal input device 3. Then, the uppermost velocity limit is transmitted through the output port 10 of the GPS receiver 1, and is then stored in the memory 20 of the velocity record arrangement 2. In addition, the user can key the lowermost velocity limit into the velocity signal input device 3. Then, the lowermost velocity limit is transmitted through the output port 10 of the GPS receiver 1, and is then stored in the memory 20 of the velocity record arrangement 2.

In such a manner, when the travel velocity of the automobile is greater than the uppermost velocity limit stored in the memory 20 of the velocity record arrangement 2 or smaller than the lowermost velocity limit stored in the memory 20 of the velocity record arrangement 2, the output port 21 of the velocity record arrangement 2 immediately outputs a signal to the warning device 5 so as to emit a warning sound or warning light to remind the user, thereby providing a warning effect to the user.

Accordingly, when the travel velocity of the automobile is greater than the uppermost velocity limit or smaller than the lowermost velocity limit, the warning device 5 is driven so as to emit a warning sound or warning light to remind the user, thereby providing a warning effect to the user, so as to protect the driver's safety during movement of the automobile.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. A velocity detector, comprising:
a GPS (Global Positioning System) receiver having an output port;
a velocity record arrangement connected to the output port of the GPS receiver and provided with a memory and an output port;
a velocity signal input device connected to the GPS receiver; and
a warning device connected to the output port of the velocity record arrangement.

2. The velocity detector in accordance with claim 1, wherein the GPS receiver is mounted on an automobile.

3. The velocity detector in accordance with claim 2, wherein when the automobile is traveled at different velocities, the GPS receiver produces different velocity signals, and the velocity signals are transmitted outward through the output port of the GPS receiver.

4. The velocity detector in accordance with claim 3, wherein the velocity record arrangement receives the velocity signals from the output port of the GPS receiver.

5. The velocity detector in accordance with claim 3, wherein the memory of the velocity record arrangement stores the velocity signals from the output port of the GPS receiver.

6. The velocity detector in accordance with claim 1, wherein the velocity signal input device inputs a predetermined velocity value into the GPS receiver.

7. The velocity detector in accordance with claim 1, wherein the warning device is a buzzer.

8. The velocity detector in accordance with claim 1, wherein the warning device is a warning lamp.

9. The velocity detector in accordance with claim 1, further comprising a release button connected to the velocity record arrangement so as to release a velocity value recorded in the velocity record arrangement when the release button is pressed by a user, so that the user can reset the predetermined velocity value.
